(19) United States
(12) Patent Application Publication
(10) Pub. No.: US 2004/0228521 A1
(43) Pub. Date: Nov. 18, 2004

(54) Real-time three-dimensional image processing system for non-parallel optical axis and method thereof

(76) Inventors: Hong Jeong, Pohang (KR); Youns Oh, Pohang (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/795,777

(22) Filed: Mar. 8, 2004

Related U.S. Application Data
(63) Continuation of application No. PCT/KR02/01700, filed on Sep. 10, 2002.

(30) Foreign Application Priority Data
Sep. 10, 2001 (KR) 2001-55533

(51) Int. Cl. H04L 27/06

(52) U.S. Cl. 382/154

(57) ABSTRACT

The present invention is a real-time three-dimensional image processing system and a method with non-parallel optical axis cameras thereof which is a system for calculating a position and a form in a three-dimensional space, wherein an angle between a pair of non-parallel optical axis, that is, an angle between a pair of cameras, is controlled by far and near distances so as to measure a subject in an optimum state, thereby expanding an observable field of view, and a system parameter is differently set according to an angle between the optical axis, thereby maximizing an image matching.

### RELATED APPLICATIONS

This application is a continuation application under 35 U.S.C. § 365(c) claiming the benefit of the filing date of PCT Application No. PCT/KR02/01700 designating the United States, filed Sep. 10, 2002. The PCT Application was published in English as WO 03/024123 A1 on Mar. 20, 2003, and claims the benefit of the earlier filing date of Korean Patent Application No. 2001-55533, filed Sep. 10, 2001. The contents of the Korean Patent Application No. 2001-55533 and the international application No. PCT/KR02/01700 including the publication WO 03/024123 are incorporated herein by reference in their entirety.

### TECHNICAL FIELD

The present invention relates to an image processing system, and more particularly, to a real-time three-dimensional image processing system and a method with non-parallel optical axis cameras.

### BACKGROUND ART

Generally, a real-time three-dimensional image processing system employs a processor having a stereo matching as a main part. At this time, a process for recreating space information of three dimension space from a pair of two-dimensional images is called as the stereo matching.

In a research treatise (Uemsh R. Dhond and J. K. Aggarwal. Structure from Stereo-a review. IEEE Transactions on Systems, Man, and Cybernetics, 19(6):553-572, November/December 1989), basic principle for the stereo matching is described in accordance with the conventional art employing the processor. Also, the substantiated art of the stereo matching is disclosed in a real-time three-dimensional image matching system (Korean Patent Application 2000-41424).

The system according to the conventional art comprises a pair of cameras having the same optical characteristics. If the pair of cameras lighten a same space region, similar space regions are respectively selected to each horizontal image scan line of the cameras. Accordingly, in the same way that pairs of pixels of the scan lines correspond to each point of the thee-dimensional space, pixels in one image are matched to those in another image. By using a simple geometrical characteristic, a distance from the pair of cameras to a point in the three-dimensional space can be measured. Herein, a difference between a position of a predetermined pixel in an image selected from one camera and a position of a predetermined pixel corresponding to an image selected from the other camera is called as a disparity. Also, the geometrical characteristic calculated from the disparity is called as “depth”. That is, the disparity comprises distance information. Accordingly, if the disparity value is calculated from inputted images real-time, three-dimensional distance information and form information of an observation space can be measured.

However, in the system according to the conventional art, the disparity value is calculated to recognize space information only in a state that two cameras are parallel put. When a near object is observed, the object is not observed in an optimum state by said method. That is, when a far object is observed, if angles formed at a pair of cameras are parallel, the disparity is not great, thereby having no problem. However, when a near object is observed in a state that the angles formed at the pair of cameras are parallel, a measured disparity is too great or exceeds a measurement range of the system and an observation object is not normally reflected on each image of the parallel cameras, thereby having a problem in the image matching.

Actually, when the system is realized with an application specific integrated circuit-chip (ASIC-chip), the real-time three-dimensional image matching system in accordance with the conventional art had a problem that a space of a memory unit occupies many parts in an entire processor.

Also, a forward processor and a backward processor are alternately operated in the system. Accordingly, when one processor is operated, the other processor is obliged to stand idle, thereby not being efficient and having a slow processing speed.

### DISCLOSURE OF THE INVENTION

Therefore, an object of the present invention is to provide a system for calculating a position and a form in three-dimensional space and a method thereof, in which an observation is facilitated by controlling a camera angle according to a position of an object, and a disparity value is prevented from being overflowed above a predetermined value.

Also, another object of the present invention is to provide a system for controlling a reference offset value of an outputted disparity and a method thereof, in which if it is assumed that the uppermost processing element represents the maximum disparity value, the lowermost processing element represents the minimum disparity value, and a base processing element has ‘0’ as a disparity value, a position of the base processing element is properly set.

Also, still another object of the present invention is to provide a system which reduces a fabricating cost by replacing the conventional memory unit by a cheap external memory device and a method thereof.

Also, still the other object of the present invention is to provide a system which can obtain a performance faster than the conventional art more than two times by alternately storing a processed decision value in one memory device between two memory devices and thereby consecutively operating forward and backward processors and a method thereof.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a real-time three-dimensional image processing system with non-parallel optical axis according to the present invention;

FIG. 2 is a detail view of an image matching unit of FIG. 1;

FIG. 3 is a detail view of a processing element of FIG. 2;

FIG. 4 is a detail view of a forward processor of FIG. 3;

FIG. 5 is a detail view of a path comparator of FIG. 4;

FIG. 6 is a detail view of a accumulated cost register of FIG. 4; and

FIG. 7 is a detail view of a backward processor of FIG. 3.

### MODE FOR CARRYING OUT THE PREFERRED EMBODIMENTS

If it is assumed that a camera performs the same performance with a man's eyes, a pair of cameras can capture an image regardless of a distance in an optimum state by controlling a focus direction according to far and near. Accordingly, so as to change an observation eye of a camera according to the far and near, a means for controlling an angle of the camera and a means for renewing a setting of an image matching system according to a control of the angle are required. By said means, even a near object is well measured and more effective image matching is possible.

The present invention will now be described with reference to accompanying drawings.

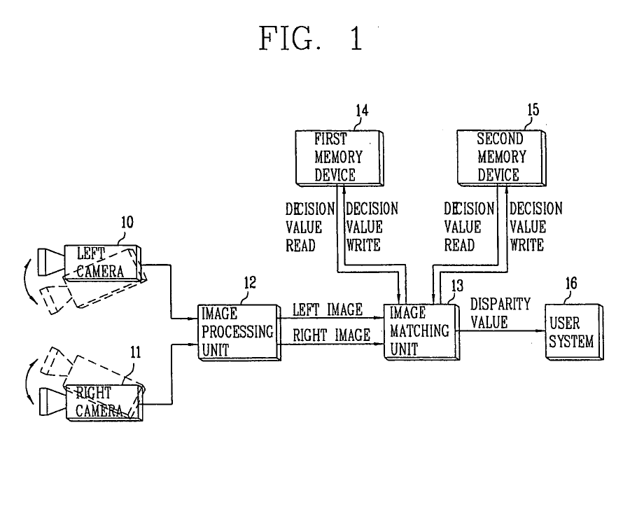

FIG. 1 is a block diagram showing a real-time three-dimensional image processing system with non-parallel optical axis according to the present invention. The system in FIG. 1 comprises a left camera 10 and a right camera 11 having optical axis rotations, an image processing unit 12 for temporarily storing digital image signals of the left and right cameras 10 and 11 or converting an analogue image signal into a digital, thereby respectively outputting the digital image signals, an image matching unit 13 for calculating a decision value representing the minimum matching cost from the left and right digital image signals and then for outputting a disparity value according to the decision value, a user system 16 for displaying images by the disparity value, and first and second memory devices 14 and 15 for alternately storing the decision value so as to provide the decision value to the image matching unit 13.

Herein, though a rotation axis of the cameras 10 and 11 is not illustrated in FIG. 1, a cylindrical body (not shown) constituting a lens part (not shown) of the cameras 10 and 11 can be rotated or an entire camera body can be rotated as shown in FIG. 1, of which detailed explanations will be omitted.

The image processing unit 12 processes images of an object obtained from the left camera 10 and the right camera 11, and outputs digitally converted left and right images to the image matching unit 13 in the form of pixels. Then, the image matching unit 13 sequentially receives pixel data of each scan line of the left and right images, calculates a decision value of the left and right images, stores the calculated decision value in one memory device between the first and second memory devices 14 and 15, and reads a previously stored decision value in the other memory device, in which the storage and reading are alternately performed. Therefore, a disparity value is calculated from the read decision value and outputted to the user system 16. Also, a process for outputting the disparity value is repeatedly performed for all pairs of scan line from the two images.

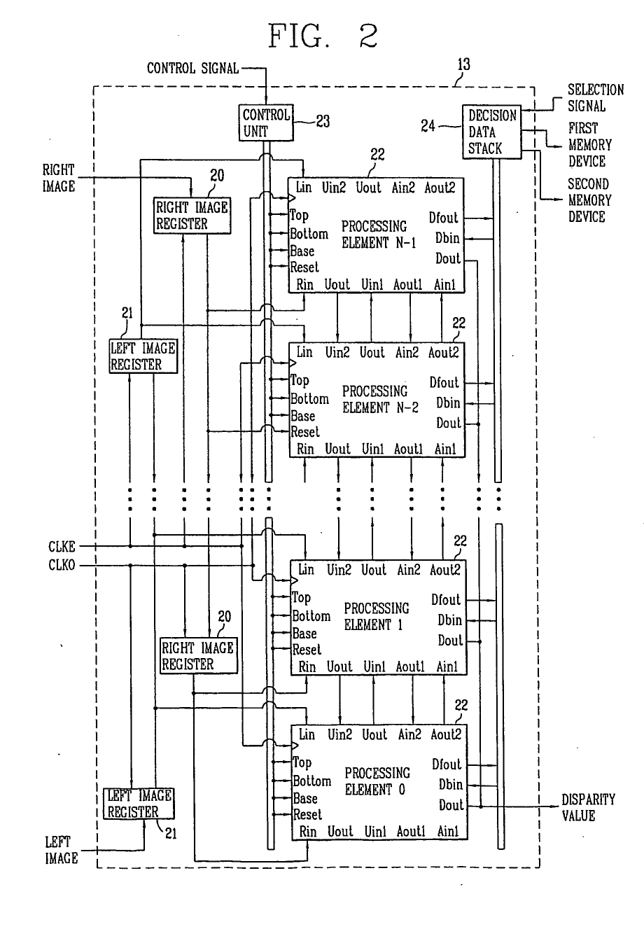

FIG. 2 is a detail view of the image matching unit of FIG. 1. The image matching unit 13 in FIG. 2 comprises N/2 left image registers 20 and N/2 right image registers 21 for respectively storing left and right image signals of the image processing unit 12, N processing elements 22 for calculating a decision value from images inputted from the left and right image registers 20 and 21 synchronous to the clock signals (CLKE, CLKO) and for outputting a disparity value (Dout), a decision value buffer 24 for alternately exchanging the decision value with the first and second memory devices by a selection signal, and a control unit 23 for controlling the processing elements 22 by setting signals (a top signal, a bottom signal, a base signal, and a reset signal) which set register values 43 of the processing elements 22 by receiving an external control signal.

A method for processing a pair of scan lines by the image matching unit will be explained.

First, the control unit 23 receives the external control signal and outputs the top, bottom, base, and reset signals to the N processing elements 22. At this time, the top signal is activated in the uppermost processing element among the processing elements in a range of a disparity value, and the bottom signal is activated in the lowermost processing element. Also, the base signal is activated in a processing element of a proper position of which disparity value is ‘0’ so as to optimize the disparity value between the processing element activated by the top signal and the processing element activated by the bottom signal according to an optical axis angle of the pair of cameras 10 and 11 by a distance from a subject.

Herein, as shown in FIG. 2, if it is assumed that a processing element (N−1) located at the uppermost position among the several processing elements 22 is defined as the uppermost processing element, a processing element (0) located at the lowermost position is defined as the lowermost processing element, and a disparity value in a position of the processing element in which the base signal is active is defined as ‘0’, a disparity value below the disparity value of ‘0’ becomes −1 and a disparity value below the disparity value of ‘−1’ becomes −2. That is, the uppermost processing element and the lowermost processing element have the minimum and the maximum of the disparity value.

The image registers 20 and 21 receive pixel data of each scan line of left and right images digitally converted from the image processing unit 12 and output the pixel data to the processing elements 22. At this time, the processing elements 22 can be reproduced as a linear array form up to a preset maximum disparity value, and each processing element 22 can exchange information with adjacent processing elements. By said structure, the system can be operated with the maximum speed regardless of the number of the processing elements 22.

The image registers 20 and 21 store image data of each pixel in each corresponding system clock, and each activated processing element calculate a decision value from the left and right images. At this time, the decision value buffer 24 alternately stores the calculated decision value calculated from the processing elements 22 in the first memory device 14 or the second memory device 15, and alternately reads the decision value from the first and second memory devices 14 and 15, thereby inputting to the processing elements 22. That is, the decision value buffer 24 stores the decision value calculated from the processing elements 22 in one memory device between the first and second memory devices 14 and 15, and inputs the decision value read from the other memory device to the processing elements 22 by a selection signal. Herein, the selection signal represents whether a data of the first memory device 14 is accessed or a data of the second memory device 15 is accessed.

The processing elements 22 input the decision value alternately read from the first memory device 14 or the second memory device 15 by the decision value buffer 24, and compute a disparity value, thereby outputting to the user system 16. At this time, the disparity value can be outputted as a sensitization form such as the actual value, or as an offset relative to the previous disparity value.

Herein, the image registers 20 and 21 and the processing elements 22 are controlled by two clock signals (CLKE) (CLKO) derived from a system clock. The clock (CLKE) is toggled on an even-numbered system clock cycles (an initial system clock cycle is supposed as ‘0’) and supplied to the image register 20 that store the right image and to even-numbered processing elements 22. Also, the clock signal (CLKO) is toggled on an odd-numbered system clock cycles and supplied to the image register 21 that store the left image and to odd-numbered processing elements 22. Accordingly, the image registers 20 or 21 and the even numbered or the odd numbered processing elements 22 are operated at each system clock cycle by starting from the image register 20 and the even numbered processing elements 22.

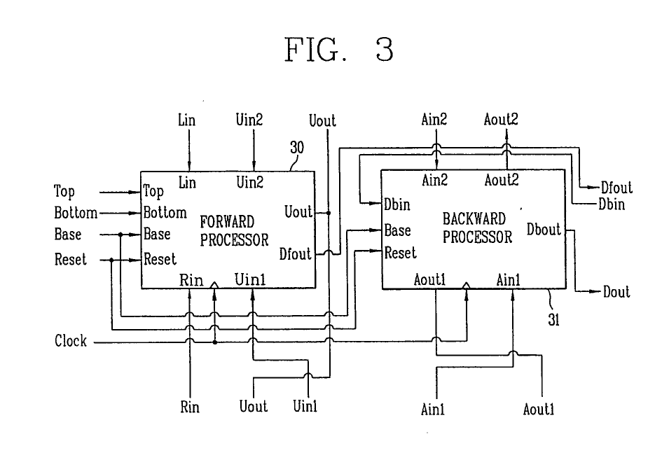

FIG. 3 is a detail view of the processing elements 22 of FIG. 2. The processing element 22 in FIG. 3 comprises a forward processor 30 for receiving scan line pixels stored in the image registers 20 and 21 and outputting an accumulated matching cost to the adjacent processing elements and a decision value to the decision value buffer 24, and a backward processor 31 for receiving the decision value (Dbin) outputted from the decision value buffer 24 and outputting a disparity value.

The operation of the processing element 22 will be explained in detail.

The processing element 22 is initialized by a reset signal in which an accumulated cost register value of the forward processor 30 and an active register value of the backward processor 31 are initiated. That is, if an active base signal is inputted to the processing element at first, the accumulated cost register value of the forward processor 30 becomes ‘0’ and the active register value of the backward processor 31 becomes ‘1’. On the contrary, if a base signal which is not active is inputted to the processing element at first, the accumulated cost register value of the forward processor 30 is initialized to nearly maximum value can be represented by the active register and the active register value of the backward processor 31 is initialized to ‘0’.

The forward processor 30 calculates a decision value (Dcout) by processing a left and right images synchronous to one of the clock signals (CLKE) (CLKO), and stores the decision value (Dcout) in the first memory device 14 or in the second memory device 15 through the decision value buffer 24.

The backward processor 31 operates the decision value read from the first memory device 14 or the second memory device 15 through the decision value buffer 24 and calculates a disparity value, thereby outputting the disparity value synchronous to one of the clock signals (CLKE) (CLKO). At this time, while the decision value calculated from the forward processor 30 is written in the one memory device between the first and second memory devices 14 and 15, the decision value is inputted to the backward processor 31 in the other memory device.

Then, when a next scan line is processed, the forward processor 30 converts the memory devices 14 and 15 for storing the decision value (Dcout) by inverting the selection signal, and the backward processor 31 also reads the decision value from the inverted memory devices 14 and 15, thereby repeating the above processes.

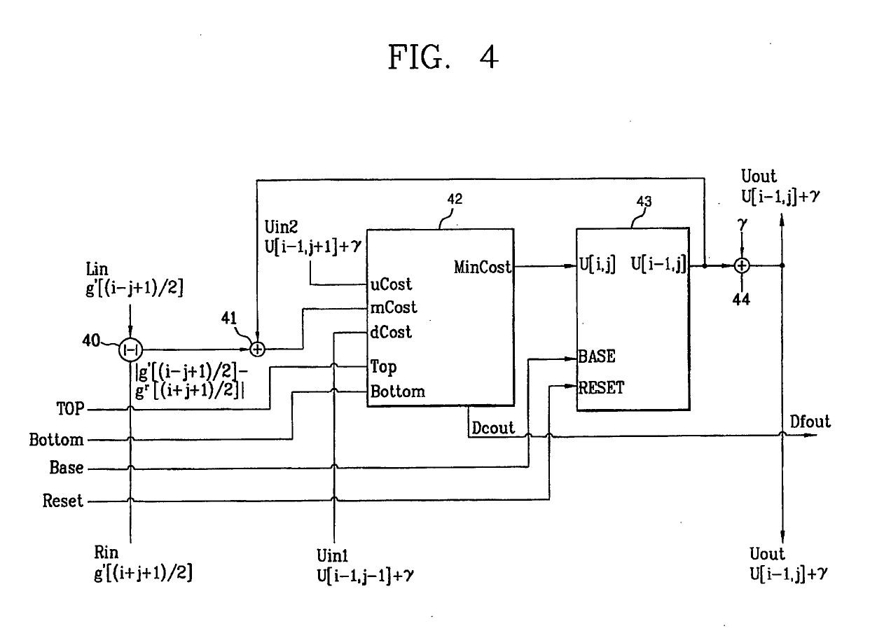

FIG. 4 is a detail view of the forward processor 30 of FIG. 3. The forward processor 30 in FIG. 4 comprises an absolute difference value calculator 40 for calculating an image matching cost through the absolute value of the difference of two pixels of the scan lines outputted from the image registers 20 and 21, a first adder 41 for adding the matching cost calculated from the absolute difference value calculator 40 to an accumulated cost fed-back from an accumulated cost register 43 which will be later explained, a path comparator 42 for receiving the output value from the first adder 41 and the accumulated costs of the adjacent processing elements 22, and the top and bottom signals and outputting the constrained minimum accumulated cost, an accumulated cost register 43 for storing the minimum accumulated cost outputted from the path comparator 42 as the accumulated cost, and a second adder 44 for adding the accumulated cost stored in the accumulated cost register 43 to an occlusion cost and outputting the summed cost to the adjacent processing elements 22.

Herein, the base signal and the reset signal initialize the accumulated cost register 43.

FIG. 5 is a detail view of the path comparator 42 of FIG. 4. The path comparator 42 in FIG. 5 comprises the occlusion comparator 50 and the comparator 51.

The occlusion comparator 50 comprises a comparator 52 for comparing an up occlusion path accumulated cost (uCost) with a down occlusion path accumulated cost (dCost) and outputting the minimum cost input (up and down), a multiplexer (MUX) 53 for selecting the up occlusion path accumulated cost or the down occlusion path accumulated cost and outputting to the comparator 51, an AND gate 54 for performing an AND operation by receiving the bottom signal and an output of the comparator 52, and an OR gate 55 for operating the multiplexer 53 by performing an OR operation for the top signal and an output of the AND gate 54.

The comparator 51 selects the minimum cost input between an outputted minimum occlusion cost from the occlusion comparator 50 and output (mCost) of the first adder 41, thereby outputting the minimum accumulated cost (MinCost) and the “match path decision”.

The path comparator 42 prevents the up occlusion path accumulated cost (uCost) from being selected when the top signal notifying the up processing elements activated, prevents the down occlusion path accumulated cost (dCost) from being selected when the bottom signal is activated, and in other cases, selects the minimum cost among the up occlusion path accumulated cost (uCost), down occlusion path accumulated cost (dCost), and the added cost (mCost). That is, the comparator 52 outputs two values by comparing two inputs (uCost, dCost). At this time, the upper output (MinCost) represents the minimum value and the lower output indicates which is the minimum among the inputted values.

The multiplexer 53 selects one value between the two inputted values (uCost, dCost) by an output value of the OR gate 55, thereby outputting.

Operations of the forward processor 30 will be explained in detail.

First, when the top signal is active, the path comparator 42 excludes the up occlusion path accumulated cost among the up occlusion path accumulated cost, the down occlusion path accumulated cost, and the added cost, and compares only the down occlusion path accumulated cost with the added cost, thereby outputting the minimum cost. At this time, if the down occlusion path accumulated cost is the minimum value, a decision value of ‘−1’is outputted, and if the added cost (mCost) is the minimum value, a decision value of ‘0’ is outputted. Herein, if the decision value is 2 bits, ‘11’ corresponds to −1, ‘00’ corresponds to 0, and ‘01’ corresponds to +1. When the top signal is active, the OR gate 55 to which the top signal is inputted outputs an up bit (Dcout(1)=Dfout(1)) of the decision value as ‘1’ and the multiplexer 53 selects the down occlusion path accumulated cost by the decision value (Dccout) to output to the comparator 51. Therefore, the comparator 51 compares the down occlusion path accumulated cost with the added cost and outputs the minimum cost.

Also, in case that the bottom signal is active, the path comparator 42 excludes the down occlusion path accumulated cost among the up occlusion path accumulated cost, the down occlusion path accumulated cost, and the added cost, and compares only the up occlusion path accumulated cost with the added cost, thereby outputting the minimum cost and a decision value (Dbin). Since the active bottom signal is inverted and inputted to an input terminal of the other side of the AND gate 54, an output signal of the AND gate 54 becomes ‘0’. Also, since the top signal is ‘0’, an up bit (Dcout(1)=Dfout(1)) of the decision value outputted from the OR gate 55 is outputted as ‘0’.

Accordingly, since the multiplexer 53 selects the up occlusion path accumulated cost and inputs to the comparator 51, the comparator 51 compares the up occlusion path accumulated cost with the added cost to output the minimum cost.

Also, in case that neither the top signal nor the bottom signal is active, the path comparator 42 outputs the minimum cost among the up occlusion path accumulated cost, the down occlusion path accumulated cost, and the added cost, and outputs the decision value (Dcout).

The minimum cost outputted by the path comparator 42 becomes a new accumulated cost synchronous to the clock signal (CLKE or CLKO) by storing it in the accumulated cost register 43.

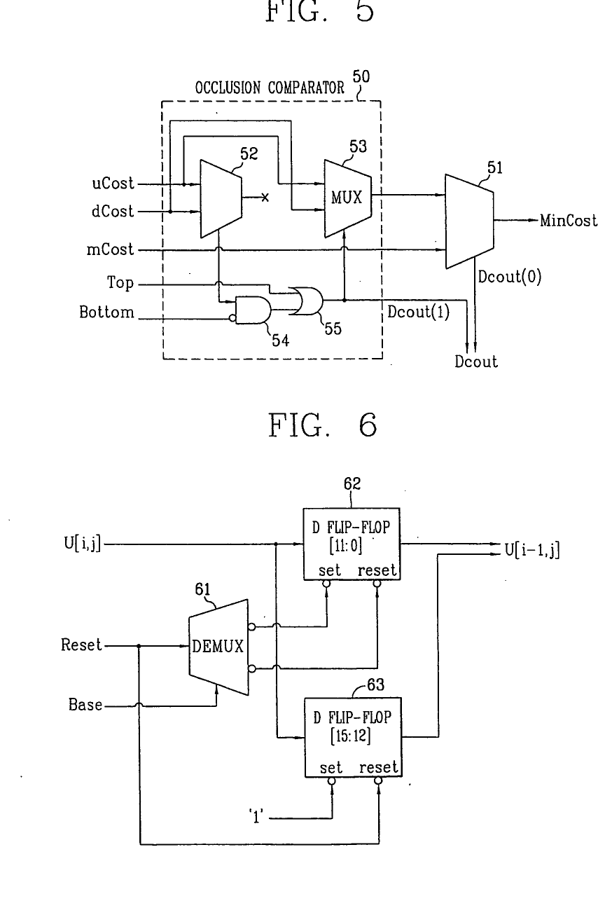

FIG. 6 is a detail view of the accumulated cost register 43 of FIG. 4. The accumulated cost register 43 in FIG. 6 receives an input of the path comparator 42, and comprises edge-triggered D-flip flops 62 and 63 which are set or cleared synchronous to the clock signal (CLKE or CLKO) when a reset signal is activated, and a demultiplexer 61 for selecting whether the D-flip flop will be set or cleared according to the base signal.

Herein, the D-flip flop 63 is not set by a fixed value ‘1’ but reset only by the reset signal.

Operations of the accumulated cost register 43 will be explained.

At a down position of the D-flip flop 62, predetermined numbers of bits among the minimum cost (MinCost=U[i,j]) are stored, and at an up position of the D-flip flop 63, predetermined numbers of bits are stored. The demultiplexer 61 inputs the set signal or the reset signal to the D-flip flop 62 by the base signal by receiving the reset signal.

The D-flip flop 63 is not set by a fixed value ‘1’ but reset only by the reset signal. An output signal (U[i−1,j]) of the D-flip flops 62 and 63 is outputted to the second adder 44. The second adder 44 adds the occlusion cost (γ) to the accumulated cost stored in the accumulated cost register 43, and outputs the summed value (Uout) to adjacent processing elements. The occlusion cost (γ) is a constant value.

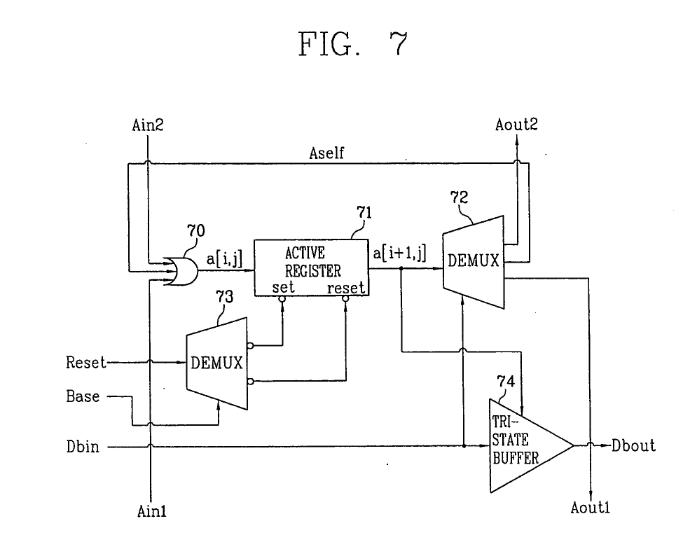

FIG. 7 is a detail view of the backward processor 31 of FIG. 3. The backward processor 31 in FIG. 7 comprises a demultiplexer 73 that directs the reset signal to the set or clear input of the active register according to base, an active register 71 composed of D-flip flops which are set or cleared by the output of the demultiplexer 73, an OR gate 70 for performing a logical OR operation using the active bit paths (Ain1, Ain2 and Aself) as inputs and outputting the result to the active register 71, a demultiplexer 72 for outputting an output value of the active register 71 according to the decision value (Dbin), and a tri-state buffer 74 for outputting the decision value (Dbin) under the control of the output of the active register 71.

Operations of the backward processor 31 will be explained.

The tri-state buffer 74, when an input value is ‘1’, outputs the input value as it is, and in other cases, does not output anything as the tri-state buffer becomes a high impedance state.

When the active register 71 has a value of ‘1’, the tri-state buffer 74 outputs the input value (Dbin), and when the active register 71 has a value of ‘0’, the output of the tri-state buffer is placed in the high impedance state.

The OR gate 70 performs a logical OR operation using three inputs; the active bit paths (Ain1, Ain2) of the adjacent processing elements 22 and the fed-back active bit path (Aself). The result is outputted to the active register 71. The input terminal (Ain1) is connected to an output terminal (Aout2) of a downwardly adjacent processing element, and the input terminal (Ain2) is connected to an output terminal (Aout2) of an upwardly adjacent processing element. The input terminals Ain1 and Ain2 represent paths by which an active bit datum output from the active register 71 of adjacent processing elements can be transmitted. Accordingly, if the active bit (Aself) is a high state, an output signal of the OR gate 70 becomes a high state.

The input signals (Ain1, Ain2) maintain a state of the active bit in the active register 71 when the clock is applied to the path of the active bit, and a new value of the active bit is stored into the active register 71 when the clock is applied to the backward processor 31.

The demultiplexer 72 is controlled by the decision value (Dbin) read from the first and second memory devices 14 and 15. The output signals (Aout1, Aself and Aout2) of the demultiplexer 72 have the same value as the ouput of the active bit when the decision values (Dbin) are −1, 0, and +1, respectively, otherwise they are ‘0’.

The tri-state buffer 74 outputs the decision value (Dbin) as a disparity value (Dbout=Dout) when the output of the active register 71 is ‘1’. If the output of the active register 71 is ‘0’, the output (Dbout) of the tri-state buffer 74 is placed in a high impedance state, thereby avoiding any conflict with the output (Dbout) of the processing element.

Also, the disparity value can be outputted instead of the decision value (Dbin), which represents an actual disparity value differently from a case that the disparity value is relatively changed by outputting the decision value (Dbin).

In the meantime, the algorithm for matching each pixel in pairs of the scan lines according to preferred embodiments of the present invention will be explained.

The control unit 23 sets the top signal, the bottom signal, and the base signal as follows.

A number of a processing element in which the top signal is activated: j_{TOP}

A number of a processing element in which the bottom signal is activated: j_{BOTTOM}

A number of a processing element in which the base signal is activated: j_{BASE}

0≦j_{TOP}≦j_{BASE}≦j_{BOTTOM}<N−1

Herein, U[i,j] is the accumulated cost register 43 value of the forward processor 30 of the j^{th} processing element in i^{th} clock cycle. That is, the U[i,j] is an accumulated cost register 43 value of the j^{th} forward processor 30 in i^{th} step.

First, the initialization operation will be explained.

In initializing the system of the present invention, the accumulated costs of all the accumulated cost registers except j_{BASE}^{th} accumulated cost register are set to a value (∞) that is nearly the maximum value that can be represented.

That is, U[0, j_{BASE}]=0,

U[0, j]=∞, herein, jε{0, j_{BASE-1}, . . . , j_{BASE+1}, . . . , N−1}

Then, operations of the forward processor and the backward processor will be explained.

The forward processor searches the best path and cost by using the following algorithm for each step i and each processing element j.

```
For i = 1 to 2N do;
    For each j ∈ {0, ... , N−1}:
    if i+j is even:
      U[i,j] = min _{k∈{-1,0,1},j+k ∈{j}_{_{BOT,}}_{J}_{_{TOP}}_{}} U[i − 1, j + k]+ rk²
      P_{M}[i, j]=arg min _{k∈{-1,0,1},j+k ∈{j}_{_{BOT,}}ⱼ_{_{TOP}}_{}} U[i − 1, j + k]+ rk²
    if i+j is odd:
  U[i,j] = U[i − 1, j] + | g^{l}[(i − j + 1)/2] − g^{r}[(i + j + 1)/2] |
      P_{M}[i,j] = 0
```

Herein, P_{M} and P_{M}′ respectively correspond to the first memory device 14 and the second memory device 15, or to the second memory device 15 and the first memory device 14, and stores the decision value which is an output value of the forward processor 30. g^{l}[i], g^{r}[i] represents i^{th} pixel value on the same horizontal lines of the left and right images, respectively. Also, γ is the occlusion cost in a case that predetermined pixels in one image do not correspond to predetermined pixels to be matched in another image. The γ is defined by a parameter.

For example, the forward processing method in the third processing element in the fifth clock will be explained.

In the fifth clock and in the third processing element, the sum of 5 and 3 is an even number, so that the accumulated cost register value of the up processing element (the accumulated cost register value of the fourth processing element), the accumulated cost register value of the down processing element (the accumulated cost register value of the second processing element), and its own accumulated cost register value (the accumulated cost register value of the third processing element) are respectively compared to obtain a processing element having the minimum cost. If the accumulated cost register value of the up processing element is determined as the minimum cost, ‘+1’ is outputted as the decision value, and if the accumulated cost register value of the down processing element is determined as the minimum cost, ‘−1’ is outputted as the decision value. Finally, the accumulated cost register value of the its own accumulated cost register value is determined as the minimum cost, ‘0’ is outputted as the decision value.

Also, if a sum between the number of times of the clock and a number of the processing element is an odd number, the decision value is ‘0’. However, in that case, information for the i^{th} pixel value on the same horizontal line in the left and right images is included, thereby including image information which was not represented at the forward processor step.

The backward processor generates the disparity value and outputs by the decision value which is a result of the forward processor through the following algorithm.

For i = 1 to 2N do;
D[i−1] = d[i] + P_{M} [i,d(I)]

Herein, P_{M}′[i,d(i)] represents a decision value outputted through the backward processor having the activated bit of ‘1’ in the i^{th} clock by reading from the first memory device or the second memory device.

The active register 71 is initialized at first by the reset signal and the base signal which are activated by the control unit 23. The decision value outputted from the forward processor 30 is stored in the P_{M}[i,j], at the same time, the backward processor 31 reads the decision value (Dout) of P_{M}′[i,j] stored in the previous scan lines, and the P_{M}[i,j] and the P_{M}′[i,j] correspond to the first and second memory devices 14 and 15 as stacks having a structure of last in first out (LIFO).

Also, when the forward processor and the backward processor which are performed at the same time are finished, the P_{M}[i,j] and the P_{M}′[i,j] are respectively changed into the second memory device 15 and the first memory device 14 to process a next processing. If the processing is finished, a role is again changed.

The forward processor and the backward processor are in parallel processed by using a processing element.

### INDUSTRIAL APPLICABILITY

As so far described, in the present invention, a position and a form in three-dimensional space can be calculated by facilitating an observation by controlling a camera angle according to a position of an object, and a disparity value is prevented from being overflowed above a predetermined value.

Also, whereas the disparity value had a constant range of amount in the conventional system, in the present invention the disparity value had different ranges fit to a measurement range according to an angle of a camera optical axis. That is, if it is assumed that the uppermost processing element represents the maximum disparity value, the lowermost processing element represents the minimum disparity value, and a base processing element has ‘0’ as a disparity value, a position of the base processing element is properly set, thereby controlling a base offset value of the outputted disparity, that is, a size value.

Also, in the present invention, the maximum and the minimum ranges of the disparity are limited by a setting of the uppermost, the lowermost, and the base processing element. Accordingly, the disparity value range limiting means is further included so as to prevent a wrong disparity output when the disparity range is exceeded by noise generated at an external environment. Actually, when the system is realized with ASIC chip, in the real-time three-dimensional image matching system according to the conventional art, a space of a memory unit occupies many parts in the entire processor. However, in the present invention, a fabricating cost is reduced by replacing the conventional memory unit by a cheap external memory device.

Also, in the present invention, two external memory devices having the stack performances are added. Accordingly, while the forward processor stores the processed decision value into the first external memory device, the backward processor reads the stored decision value from the second external memory device, and when next image scan lines are processed, while the forward processor stores the processed decision value into the second external memory device, the backward processor reads the stored decision value from the first external memory device. Therefore, the system alternately stores the processed decision value into the one memory device between the two memory devices, so that the forward and backward processors are consecutively operated, thereby having a faster performance more than two times than the conventional art.

1. A real-time three-dimensional image processing system comprising:
an optical axis control means for controlling an optical axis angle of left and right cameras by far and near distances of a subject;
an image processing unit for temporarily storing digital image signals of the left and right cameras and converting an analogue image signal into a digital, thereby respectively outputting the digital image signals;
an image matching unit for calculating a decision value representing a minimum matching cost from the left and right digital image signals and then for outputting a disparity value according to the decision value; and
first and second memory devices for alternately storing the decision value.

2. The system of claim 1, further comprising a display means for displaying image that processed in accordance with the disparity value.

3. The system of claim 1, wherein the image matching unit comprises:
left and right image registers for respectively storing image signals of the left and right cameras;
a processing means for calculating the decision value from images inputted from the left and right image registers by a clock signal and then for outputting the disparity value;
an input/output decision value buffer for alternately exchanging the decision value with the first and second memory devices from an external selection signal; and
a control unit for controlling the processing means by using setting signals which set a register value of the processing means by receiving an external control signal.

4. The system of claim 3, wherein the setting signals comprises a top signal for activating the uppermost processing means among the processing means in a range of the disparity value; a bottom signal for activating the lowermost processing means among the processing means in a range of the disparity value; a base signal for activating a processing means placed at a position having a disparity ‘0’ among the processing means in a range of the disparity value; and a reset signal for initializing the processing means,

5. The system of claim 3, wherein the decision value buffer alternately stores the decision value calculated from the processing means in the first memory device or the second memory device, and reads the decision value from the first and second memory devices alternately to output to the processing means.

6. The system of claim 3, wherein the processing means comprises:
a forward processing means for calculating a matching cost by receiving a pixel of a scan line stored at the image register and then for outputting the calculated decision value to the decision value buffer; and
a backward processing means controlled by the base and the reset signals for outputting a disparity value by receiving the decision value (Dbin) from the decision value buffer.

7. The system of claim 6, wherein the decision value outputted from the forward processing means is inputted to the decision value buffer means, and the decision value outputted from the decision value buffer means is inputted to the backward processing means.

8. The system of claim 6, wherein the forward processing means comprises:
a path comparison means for calculating a matching cost by a difference of each pixel of the scan lines outputted from the left and right image registers, adding the matching cost to an accumulated cost which is fed-back from a accumulated cost register, and receiving the added cost, an accumulated cost of the uppermost processing means, and an accumulated cost of the lowermost processing means by a setting of the top and bottom signals, thereby outputting the minimum cost among the three costs; and
an accumulated cost storage means for storing the minimum cost as an entire cost and adding the entire cost to an occlusion cost, thereby outputting the added cost to an adjacent processing means.

9. The system of claim 8, wherein the path comparison means comprises:
an occlusion comparison means for receiving the uppermost and the lowermost costs by comparing the inputted three costs, selecting the lowermost cost when the top signal notifying the uppermost processing means is activated, selecting the uppermost cost when the base signal notifying the lowermost processing means is activated, and selecting the minimum cost among the inputted costs in other cases; and
a comparator for selecting a cost which is neither the uppermost cost nor the lowermost cost among the three inputted costs and the minimum cost among the costs outputted from the limitation setting means.

10. The system of claim 8, wherein the cost storage means comprises:
a D-flip flop which is set or cleared; and
a demultiplexer for setting or clearing the D-flip flop according to a base signal by receiving the reset signal.

11. The system of claim 8, wherein when the reset signal is activated, the accumulated cost storage means gets the accumulated cost storage means of the processing means having an active base signal have a smaller value than the accumulated cost storage means of the rest processing means.

12. The system of claim 6, wherein the backward processing means comprises:
a first demultiplexer for outputting the reset signal to a reset of an activated register or a set according to a base signal by receiving the reset signal;
an active register composed of D-flip flops which are set or reset by a control of the first demultiplexer;
an OR gate for receiving active bits, adding the active bits logically, and outputting to the active register;
a second demultiplexer for outputting an output value of the active register according to the decision value; and
a tri-state buffer for outputting the decision value by a control of the active register.

13. The system of claim 12, wherein when the reset signal is active, the active register activates only an active register of the processing means in which the base signal is active.

14. A real-time three-dimensional image processing system comprising:
an angle control means between a pair of cameras;
a control means for controlling the maximum and the minimum values of a disparity for an optimum image matching by a measured distance; and
a processing means for alternately using two memory devices so as to consecutively operating a backward processor and a forward processor.

15. A real-time three-dimensional image processing system comprising:
a means for observing a subject at an optimum state by controlling an angle between a pair of non-parallel optical axis;
a processing element setting means for limiting a range of a disparity by controlling an offset value of the disparity according to an angle between camera optical axis;
a means for storing and reading the decision value for an external memory device connected to the processing element setting means; and
an interface means for alternately using first and second memory devices for storing or reading the decision value.

16. A method for a real-time three-dimensional image processing system comprising the steps of:
controlling optical axis values of left and right cameras for an optimum observation and an efficient image matching by far and near distances of a subject;
digitally-converting image signals of the left and right cameras; and
calculating a decision value from the digitally converted image signals of the left and right cameras and then outputting a disparity value by the decision value.

17. The method of claim 16, wherein the step of outputting further comprises a step of alternately storing the decision value to the first and second memory devices or alternately reading the decision value from the first and second memory devices.

18. The method of claim 16, wherein the step of outputting further comprises the steps of:
receiving the digitally-converted image signals, calculating the decision value (Dbin), and storing the decision value (Dcout) to the first memory device; and
calculating a disparity value by using the stored decision value.

19. The method of claim 18, further including the steps of:
receiving next image signals, calculating a decision value, and storing the decision value into the second memory device; and
calculating a disparity value by using the stored decision value.

20. The method of claim 18, wherein the disparity value is calculated by using the decision value stored in the second memory device while the decision value is stored into the first memory device.

21. The method of claim 19, wherein the disparity value is calculated by using the decision value stored in the first memory device while the decision value is stored into the second memory device.

22. The method of claim 18, wherein the step of storing comprises the steps of:
initializing a forward processing means according to a base signal;
adding the number of times of an externally inputted clock signal to a number of a processing means used in calculating the decision value; and
calculating a decision value according to the added result.

23. The method of claim 22, wherein if the added result is an even number, it is determined which signal is active among top and bottom signals, thereby calculating each decision value according to the determination result.

24. The method of claim 23, wherein if only the top signal is active as a result of the determination, among an up cost, a down cost, and an added cost, the up cost is excluded in comparison objects, then, only the down cost and the added cost are compared to store the minimum cost, and information notifying the minimum cost between the added cost and the down cost is determined as a decision value.

25. The method of claim 23, wherein if only the bottom signal is active as a result of the determination, among the up cost, the down cost, and the added cost, the down cost is excluded in comparison objects, then, only the up cost and the added cost are compared to store the minimum cost, and information notifying the minimum cost between the added cost and the up cost is determined as a decision value.

26. The method of claim 23, wherein if neither the top signal nor the bottom signal is active as a result of the determination, the minimum cost is stored among the up cost, the down cost, and the added cost, and information notifying the minimum cost between the up cost, the added cost, and the down cost is determined as a decision value.

27. The method of claim 22, wherein if the added result is an odd number, ‘0’ is determined as a decision value, and an absolute value of a difference between inputted a pair of image pixel values is added to a stored cost.

28. The method of claim 18, wherein the step of calculating comprises the steps of:
initializing a backward processing means by a base signal; and
receiving a decision value of an activated processing means, adding the inputted decision value to a previously calculated disparity value, and outputting the added value as a disparity value.
